(19) United States
(12) Patent Application Publication
(10) Pub. No.: US 2003/0084597 A1
(43) Pub. Date: May 8, 2003

(54) Information marking plate

(76) Inventor: David M. Beausoleil, Hawthorne, NJ (US)

Correspondence Address: Richard A. Catalina, Jr., Esq., CATALINA & ASSOCIATES, 167 Avenue at the Common, Suite 9, Second Floor, Shrewsbury, NJ, 07702, US

(21) Appl. No.: 10/006,643

(22) Filed: Nov. 8, 2001

(51) Int. Cl. G09F 3/10; G09F 3/08

(52) U.S. Cl. 40/299.01; 40/662

(57) ABSTRACT

An improved information marking plate used to record data for easy reference. Although the present invention has many applications, a primary objective of the present invention is that it be used to record basic and essential electrical information concerning electric fixtures, receptacles, and devices, in both high voltage and low voltage environments.

A preferred embodiment of the invention is a marking plate comprised of stainless steel, or any other rigid, non-corrosive material, on which an information template is recorded to at least one (1) side of the marking plate. The information template is comprised of an array of relevant electrical information concerning a particular electrical fixture, receptacle, switch, splice, outlet, junction box, or any other electrical device commonly known to those skilled in the art. When installing an electric fixture or device, information specific to that device is punch holed, written, engraved or etched onto the information template previously recorded onto the surface of the marking plate. The information marking plate is then attached to the corresponding electrical fixture or device. The preferred embodiment to be used for low voltage electric landscape lighting fixtures would provide basic and important information with respect to the corresponding electric fixture or device, and in particular, would provide such information as wiring identification, proper transfer identification, lamp type and wattage, number of other fixtures connected to the applicable wiring run, and any other pertinent information commonly used by and known to those skilled in the art.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF INVENTION

1) Field of Invention

The present invention relates to an improved information marking plate in which information is transcribed or recorded for easy reference. Although the present invention has many applications, a primary objective of the present invention is that it be used to record basic and essential electrical information concerning electric fixtures, receptacles, and devices, in both high voltage and low voltage environments.

A preferred embodiment of the invention is a stainless steel marking plate wherein certain information regarding low voltage outdoor landscape lighting fixtures, including, but not limited to, information such as wiring systems or runs, transformers, lamp size, type and wattage, circuitry, and other relevant information generally relied upon by electricians and those skilled in the art, is recorded to an information template pre-recorded onto at least one side of the marking plate. Specific electrical information concerning the low voltage electric landscape lighting fixture is recorded to the information template by punching a hole or otherwise marking the corresponding data box or area of the information template on the marking plate. After that information is recorded to the information template, the entire information marking plate is attached to the corresponding fixture for simple and easy reference

Once the corresponding information of an electric fixture is appropriately recorded to the information template on the marking plate, the marking plate is attached or affixed to the corresponding fixture of which the information was recorded. Thereafter, when information as to that specific fixture is needed, it may be easily and readily obtained directly from the marking plate attached to that fixture. Because the information marking plate is made of stainless steel or any other rigid, non-corrosive material commonly known to those skilled in the art, the marking plate is intended to be permanent and will generally last the life of the corresponding fixture, if not longer.

In an additional embodiment of the present invention, the improved information marking plate is used with standard, high voltage electrical wiring, circuitry and fixtures. With this embodiment, information regarding a fixture's corresponding circuit number, number of other fixtures on that circuit, lamp size, type and wattage, and other relevant information generally relied upon by electricians and those skilled in the art, is recorded on the marking plate for simple and easy reference. This information is hole punched into, or marked, stamped or etched onto the information template previously recorded onto at least one side of the marking plate. Again, the marking plate is attached directly either to the interior or exterior of the corresponding fixture or receptacle, which includes, but is not limited to, indoor and outdoor electric junction boxes, fixtures, receptacles, switch boxes, outlets, lighting fixtures, or any other relevant electric fixture, box or device generally used by electricians and those skilled in the art. Because the marking plate is made of stainless steel or any other rigid, non-corrosive material commonly known to those skilled in the art, the marking plate is intended to be permanent and will generally last the life of the corresponding fixture, if not longer.

One of the many problems encountered with low or high voltage electrical circuitry or systems is the inability to easily and readily ascertain basic information concerning a specific fixture or device within that circuit system. Such information generally includes, but is not limited to, wiring run or line identification, corresponding circuit or fuse identification, lamp type, size and wattage, voltage, and any other information deemed relevant and relied upon by electricians and those skilled in the art. Often, when this information is required, individuals are faced with the difficult and time-consuming task of turning on and off specific transformers, fuse units, or circuits to determine which electrical circuitry corresponds to a particular fixture, outlet, switch box, receptacle or other electric device used within an electrical wiring system or circuit.

Other basic information with respect to low voltage outdoor landscape lighting fixtures also requires time consuming investigation. For example, with regard to low voltage outdoor electric landscape lighting, an additional and more complex problem occurs with the use of multiple lighting fixtures associated with such low voltage systems, wherein much of the wiring is underground and where it is difficult to determine specific wiring configurations and basic transformer and lamp information. Typically, with respect to low voltage outdoor electric landscape lighting, high voltage electric power is provided to a low voltage power regulator source such as a transformer. The transformer regulates or transforms the high voltage electric power down to low voltage, which is then used to power the outdoor electric landscape lighting fixtures. Low voltage electric power runs from the low voltage power source or transformer, via electric wiring, and almost always underground, to multiple low voltage electrical fixtures. After the wiring leaves the transformer, it is often split or “spliced” into multiple wiring runs to power the landscape lighting fixtures. This network of multiple wires and splices can be complex. Obtaining information regarding a particular fixture's corresponding wiring or line run number and transformer identification is therefore burdensome, difficult and time consuming. The present invention squarely resolves this problem by recording all relevant information concerning that fixture to an improved information marking plate, which is then affixed directly to the fixture.

With respect to low voltage electric landscape lighting, the preferred embodiment of the present invention discloses a stainless steel plate, rectangular in shape, approximately two (2) inches by three (3) inches in size and approximately one-sixteenth (1/16) of an inch in thickness or width, (i.e., twenty-two (22) gauge thickness) wherein an information template is recorded to at least one side of the plate by engraving, writing, laser etching, acid etching, or by printing using baked enamel, or by any other means generally known to those skilled in the art, for creating a durable, non-corrosive and permanent data template on the surface of at least one side of the marking plate. The information template contains all relevant information regarding a particular lighting or wiring run, transformer identification, lamp type, size and wattage used in the corresponding fixture, number of electrical fixtures on a particular wiring run, and any other information deemed relevant by an electrician or one skilled in the art. As an example, in one embodiment, the information template is designed and organized to accommodate up to 150 separate wire runs, 38 separate transformers, as well as, multiple lamp sizes, including wattage. The information template also provides a miscellaneous category for additional lighting characteristics including kilowatt-hours and additional bulb characteristics such as bulb type, which would include, but not be limited to, halogen, bayonet or an incandescent bulb. The information template, permanently recorded to the marking plate, comprises a single and effective means of providing an all-encompassing data checklist or chart, from which specific information concerning a particular fixture or receptacle is selected and marked for easy future reference.

Generally, the relevant information is recorded on the marking plate at the time that a fixture is actually connected to the wiring and installed, when such information is immediately known to or by one installing the fixture. The recording of such information is easily accomplished by appropriately marking the information template on the marking plate. Marking the information template may take many forms, including punching a hole in the corresponding information data area or box of the template, engraving or etching that area, or otherwise marking that area with durable, permanent and/or waterproof ink, paint or other media. Once a particular electrical fixture is installed, the relevant information would be recorded on the marking plate by way of a hole punch, stamp marking or a writing utensil over the corresponding information contained on the marking plate. For example, if one wishes to record wire run four (4), transformer two (2), lamp size twenty-five very narrow (25VN) and fixture three (3) of six (6), one would simply mark the corresponding boxes and/or areas on the information template that has been previously recorded to the surface of at least one side of the marking plate.

After the appropriate information is recorded to the information template on the marking plate, the marking plate is then attached to the corresponding electrical fixture. This may be accomplished by a variety of methods. An information marking plate may be attached to a fixture, such as a lighting fixture, splice fixture or receptacle, switch box and the like, by a ring clasp, analogous to a key chain feature, or through any other fastening device commonly known to those skilled in the art, such as a screw, rivet or adhesive backing. As noted, the information marking plate may be utilized for both outdoor and indoor electrical fixtures, which include, but are not limited to, lighting fixtures, electric wiring splice fixtures or receptacles, junction boxes, switch boxes, outlets, or any other electric fixture, receptacle or device, and affixed in such a way as to make the marking plate itself inconspicuous. In addition, through the use of a stainless steel marking plate, same can be affixed to an outdoor fixture in an inconspicuous area; below ground level if necessary, without worry that the marking plate would corrode. With respect to interior electrical fixtures, the marking plate could be placed in a variety of areas out of sight, for example, behind a wall plate, on the underside of a lampshade, or perhaps on the interior or exterior of any of the electric boxes or receptacles commonly known to and utilized by electricians and those skilled in the art.

Having all of the necessary electrical information affixed to the electrical fixture itself provides a fast, simple and effective method of compiling key electrical data that would not have otherwise been known but for painstaking trial and error. The present invention is a simple and ready means for permanently recording substantial and detailed information for a variety of electric fixtures directly to such fixtures.

2) The Prior Art

There have been attempts in the past to create a variety of electrical schematic and device tags for electrical equipment, fixtures and receptacles. None of these disclosures, however, employ the same approach and flexibility as the present invention. Nor do they address the same needs that the present invention satisfies. Nor do any of the prior disclosures provide the ability to record the amount, scope and level of information as the present invention. For example, U.S. Pat. No. 4,479,317 discloses a transparent plate which is oversized to extend beyond the electrical receptacle so as to permit the placement of an electrical circuit identification label to be affixed in a permanent and protective manner to remain always visible. Disadvantages of U.S. Pat. No. 4,479,317 are that the disclosure is designated for interior electrical and wall outlet use only and that the label is always visible.

U.S. Pat. No. 4,734,638 discloses a complex handheld detector-indicator device, which when used in conjunction with multiple frequency pulses, assists in the identification of indoor wiring circuits. The example specifically referenced in that disclosure is a building that is undergoing subdivision into condominium or apartment units. While this device might very well assist in the identification of multiple electrical wiring schemes, its mere description raises issues of cost effectiveness and ease of use. Moreover, unlike the present invention, the disclosure in U.S. Pat. No. 4,734,638 fails to provide a simple and permanent method or apparatus for recording information. In addition, U.S. Pat. No. 4,734,638 does not provide for the amount and level of information that may be recorded by the present invention.

U.S. Pat. No. 5,487,666 references a detailed floor plan representative of a computer local area network to create a network central controller to simplify access and installation of network related details. There is no reference to the identification of electric circuitry as is disclosed by the present invention.

U.S. Pat. Nos. 5,693,911, 5,832,641 and 6,178,681 all disclose various labeling and identification methods for electrical devices. U.S. Pat. No. 5,693,911 discloses an adhesive label to be installed on the interior surface of an electrical cover plate with specific reference to the recording of information related to the type of paint used in a particular room. Significantly, there is no reference in this disclosure to electronic circuitry or any other relevant electrical information regarding a fixture.

U.S. Pat. No. 5,832,641 discloses a wiring device circuit identification to be installed between the plug-receiving portion of an electric outlet and the exterior wall plate. This certainly does not address the difficulty in determining electrical information as related to exterior landscape lighting, as well as, interior electrical fixtures and complex wiring configurations. There is also the added difficulty in that the information recorded is not readily accessible.

Finally, U.S. Pat. No. 6,178,681 discloses a merchandising tag for use on displayed electrical devices. The claimed tag is for merchandising purposes only and its objective is to provide an attractive method of providing information to customers about the particular displayed product. Noticeably absent is any reference to any information concerning electrical circuitry, wiring, and the like.

There therefore remains a need for an easily accessible electrical information marking plate, which can be attached to any electrical fixture, receptacle or device, in an inconspicuous location, if so desired, that permanently records all of the necessary and relevant information concerning that fixture, receptacle or device. The present invention squarely and effectively satisfies this need. The present invention enables one to quickly and easily obtain relevant information concerning an electrical fixture, receptacle or device, including, but not limited to, wiring or run identification, transformer identification and information, lamp size, type and wattage, corresponding circuit breaker or fuse identification, number of fixtures on a particular wiring or line run, and any other information deemed relevant by an electrician or one skilled in the art.

### SUMMARY OF THE INVENTION

The present invention is directed to an improved information marking plate, where information is recorded for easy reference. In the case of low voltage electric landscape lighting fixtures, the information to be recorded would include, but not be limited to, the particular electric circuit, such as the lighting or wiring run, transformer identification information, lamp size and type, and number of other electrical lighting fixtures on a particular wiring run. Attached to each fixture within a low voltage electric landscape lighting scheme, the improved information marking plate is available for easy reference. The primary objective of the present invention is to alleviate the difficulties associated with identifying complex electrical circuitry, particularly that which is associated with outdoor landscape lighting which likely contains a network of underground wiring.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto,

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The present invention is comprised essentially of a marking plate, which contains both a front and a rear portion, with an information template printed, engraved, etched, or baked-enamel painted onto the surface of at least one side, usually the “front” side, of the marking plate. Ideally, the marking plate is comprised of a rigid, non-corrosive material, such as stainless steel, so as to avoid corrosion, fading or deterioration in an outdoor environment. The information template is generally recorded onto the front side of the marking plate and provides all of the necessary and relevant information as to a particular electrical fixture, receptacle, device, switch, outlet, box or any other such electrical device commonly used by electricians and those skilled in the art. During installation of the electrical fixture or other such device, all relevant information regarding particular electric circuitry for that fixture or device is collected and recorded at that time, in the appropriate marking area of the information template. Recording the information with respect to a particular fixture is accomplished by marking the corresponding data area or box on the information template on the marking plate. Marking the information template may take many forms, including, but not limited to, punching a hole in the corresponding information data area or box of the template, engraving or etching that area, or otherwise marking that area with durable, permanent and/or water-proof ink, paint or other such media. The information marking plate, now with appropriate and specific information concerning the corresponding electric fixture, is then affixed to said fixture or electrical device, by way of a fastener or adhesive, generally in an inconspicuous location so as not to distort any surrounding aesthetics, yet readily available to anyone needing relevant electrical information concerning that device or fixture.

### BRIEF DESCRIPTION OF THE DRAWINGS

For a fuller understanding of the nature and object of the present invention, reference is made to the accompanying drawings, wherein:

FIG. 1 is a perspective drawing of an improved information marking plate, wherein an information template has been recorded onto the surface of one side of a marking plate, and wherein said information template displays an array of relevant information generally relied upon by electricians and those skilled in the art with respect to low voltage, outdoor landscape lighting fixtures.

FIG. 2 is an explosive perspective view of the improved information marking plate as depicted in FIG. 1, secured to the exterior surface of a low voltage electric power transformer, wherein the improved information marking plate is secured to the transformer's exterior surface by means of a fastening device, in this case, two (2) pop-rivets.

FIG. 3 is a side view of an outdoor spotlight fixture, demonstrating the information marking plate as depicted in FIG. 1, wherein said information marking plate is secured to said fixture by means of a ring clasp.

FIG. 4 is a side view of an electric splice device or receptacle, demonstrating an incoming electric line from a power source and numerous outgoing wiring runs, with the improved information marking plate as depicted in FIG. 1, secured to the splice receptacle by means of a ring clasp.

FIG. 5 is a side view of an in-ground outdoor lamp fixture, demonstrating the improved information marking plate as depicted in FIG. 1, wherein the improved information marking plate is secured to the in-ground lamp fixture by means of a ring clasp, with the information marking plate resting at ground level.

### DETAILED DESCRIPTION OF THE PREFERRED EMBODIMENTS

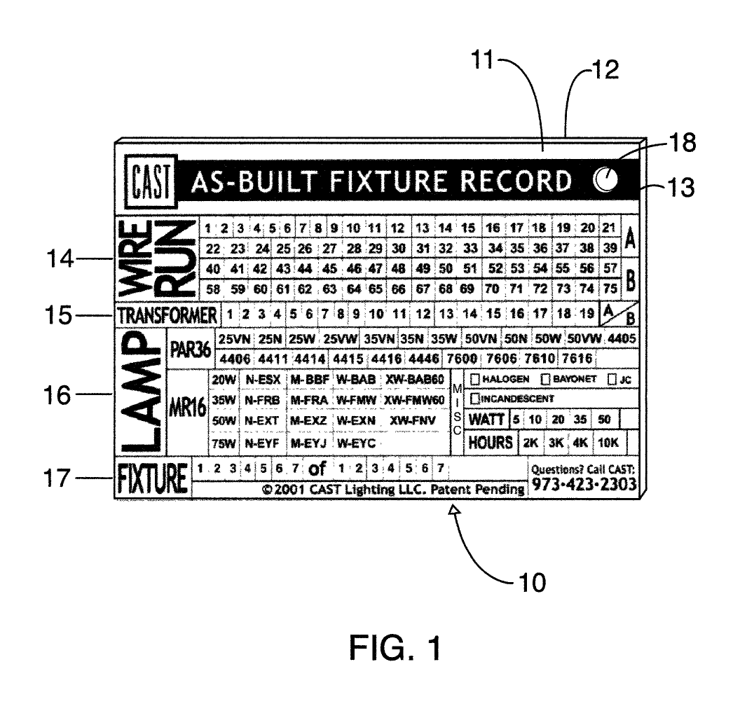

A preferred embodiment of the invention is illustrated in FIG. 1 and is designated as an improved information marking plate 10. The improved information marking plate 10 comprises two flat surfaces for receiving information for recording: a front side 11, and a backside 12. In FIG. 1, an information template 13 has been recorded to the front side 11, of the information marking plate 10, wherein an array of information generally relied upon by electricians and those skilled in the art with respect to low voltage outdoor electric landscape lighting is recorded.

In addition, in the preferred embodiment of FIG. 1, the information marking plate 10 is further comprised of stainless steel, rectangular in shape and is approximately two (2) inches by three (3) inches in size and approximately one-sixteenth (1/16) of an inch thick or wide. However, the size of the information marking plate 10 may be modified depending on dimensional requirements. The information template 13 may be recorded to either the front side 11 or the back side 12 of the information marking plate 10 by engraving, laser etching, acid etching or by printing, using baked enamel paint, or any other media generally relied upon by those skilled in the art, so as to create a durable non-corrosive and permanent information template 13 to the surface of the information marking plate 10.

In the preferred embodiment of the invention with respect to low voltage outdoor landscape lighting, FIG. 1 depicts an information marking plate 10 in which the information template 13 recorded on the front surface of the marking plate 11 comprises an array of several categories of information typically relied upon by electricians and those skilled in the art, designated therein as Wire Run 14, Transformer 15, Lamp 16 and Fixture 17. More specifically as shown in FIG. 1, the Wire Run 14 category is designed to accommodate up to 150 separate wire runs, with runs 1 through 75 corresponding to the A designation and runs 76 through 150 corresponding to the B designation within the Wire Run 14 category. In addition, FIG. 1 depicts a Transformer 15 category to address the identification of up to 38 separate transformers with transformers 1 through 19 corresponding to the A designation and transformers 20 through 38 to the B designation of the Transformer 15 category. Relevant lamp information including bulb type, size, wattage, as well as, a miscellaneous category for additional lighting characteristics including kilowatt-hours and other noted bulb types, including but not limited to halogen, bayonet and incandescent bulbs is referenced in the Lamp 16 category. Lastly, the information marking plate 10 provides one skilled in the art with a Fixture category 17 which references the number of fixtures on a particular wire run. In an additional embodiment of the present invention, the information marking plate 10 may be used in an analogous manner with standard, higher voltage electrical wiring, circuitry and fixtures as well.

Once a particular electrical fixture is installed, the relevant information regarding said fixture would then be recorded on the information marking plate 10 by way of hole punch, stamp marking or a writing utensil over the corresponding data area or box of the information template 13 contained on the information marking plate 10 itself For example, if one skilled in the art wishes to record wire run four (4), transformer two (2), lamp size twenty-five very narrow (25VN) and fixture three (3) of six (6), one would simply mark the corresponding designations noted in the Wire Run 14, Transformer 15, Lamp 16 and Fixture 17 categories on the information marking plate 10 itself as depicted in FIG. 1.

In addition, FIG. 1 depicts an information marking plate 10 which consists of an opening 18 by which the information marking plate 10 may be attached to a particular electrical device and/or fixture. It is important to highlight that the information marking plate 10 may be attached by a variety of methods in addition to the one shown.

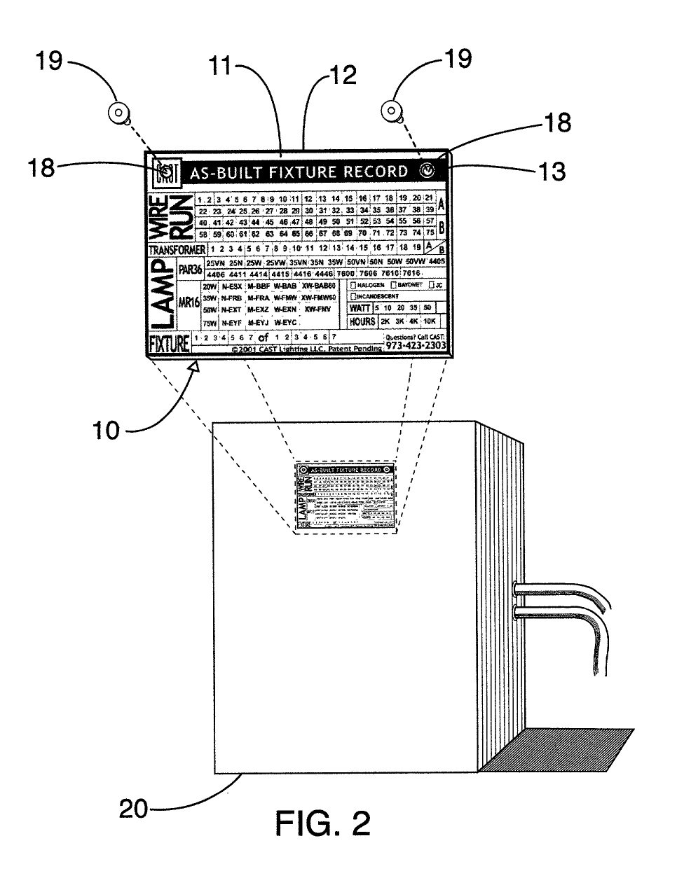

FIG. 2 shows an exploded perspective view of the information marking plate 10 being secured to the exterior surface of an electric transformer 20. The attachment means shown in FIG. 2 comprises two (2) pop-rivets 19 that are inserted through two (2) openings 18 of sufficient size to accept the rivets located in the upper corners of the information marking plate 10, and into the transformer 20, thereby securing the information marking plate 10, to the exterior surface of the transformer 20.

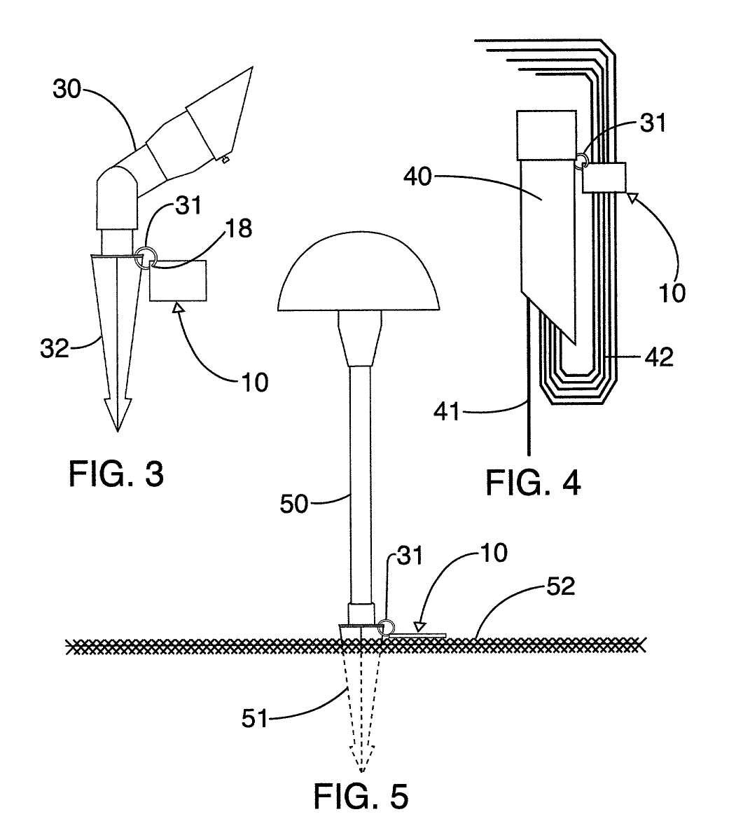

FIG. 3 depicts an information marking plate 10 secured to an outdoor spotlight fixture 30 by way of a ring clasp 31. More specifically, the ring clasp 31 is inserted through the opening 18 of the information marking plate 10 and also through a hole in the base 32 of the outdoor spotlight fixture 30.

FIG. 4 depicts a splice fixture 40 used in a complex wiring scheme or network, with one (1) incoming wire 41 passing through the splice fixture 40 and five (5) outgoing wires 42 emanating from the splice fixture 40. Attached to the splice fixture 40, by way of ring clasp 31 is an information marking plate 10.

FIG. 5 depicts a side view of an alternate outdoor lamp fixture 50, wherein the base 51 of the outdoor lamp fixture 50 is placed in the ground 52 and wherein the information marking plate 10 remains visible above ground and is secured to the base 51 of the outdoor lamp fixture 50 by means of ring clasp 31.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1) An improved information marking plate comprising;
(a) a marking plate,
(b) an information template to be recorded on at least one side of the marking plate, said information template comprised of at least one table or organized array of standardized data or information relevant to a corresponding device, of which said data or information is used by and known to those skilled in the art with respect to the device, from which device specific relevant information is selected and recorded upon the information template on the marking plate, and
(c) a means to secure the marking plate to the corresponding device.

2) The information marking plate according to claim 1, wherein the marking plate is comprised of a rigid, durable and non-corrosive material.

3) The information marking plate according to claim 2, wherein the marking plate is comprised of stainless steel.

4) The information marking plate according to claim 3, wherein the information template recorded on the marking plate is painted onto the surface of the marking plate.

5) The information marking plate according to claim 3, wherein the information template recorded on the marking plate is engraved onto the surface of the marking plate.

6) The information marking plate according to claim 3, wherein the information template is laser etched onto the surface of the marking plate.

7) The information marking plate according to claim 3, wherein the information template is acid etched onto the surface of the marking plate.

8) The information marking plate according to claim 3, wherein the information template is printed onto the surface of the marking plate.

9) The information marking plate according to any of claims 1 through 8, wherein the securing means is comprised of a ring clasp passing through a hole in the marking plate and wherein said ring clasp is to further pass through a hole into the corresponding fixture, thereby securing the information marking plate to the fixture.

10) The information marking plate according to any of claims 1 through 8, wherein the securing means is comprised of at least one pop rivet passing through a hole of sufficient size in the marking plate and into the fixture, thereby securing the information marking plate to the fixture.

11) The information marking plate according to any of claims 1 through 8, wherein the securing means is comprised of at least one screw passing through a hole of sufficient size in the marking plate and into the fixture, thereby securing the information marking plate to the fixture.

12) The information marking plate according to any of claims 1 through 8, wherein the securing means is comprised of an adhesive material applied to the side of the marking plate opposite to the side of the marking plate on which the information template is recorded, with said adhesive side of the marking plate to be affixed to the fixture, thereby securing the marking plate to the fixture.

13) An improved information marking plate for recording electrical and circuitry information for an electric fixture, said information marking plate comprising:
(a) a marking plate,
(b) an information template to be recorded on at least one side of the marking plate, said information template comprised of at least one table or organized array of standardized electrical and circuitry data relevant to the electric fixture, of which said data or information is used by and commonly known to electricians and those skilled in the art, from which fixture specific relevant electrical information is selected and recorded on the information template, and
(c) a means to secure the marking plate to the electric fixture.

14) The information marking plate according to claim 13, wherein the marking plate is comprised of a rigid, durable and non-corrosive material.

15) The information marking plate according to claim 14, wherein the marking plate is comprised of stainless steel.

16) The information marking plate according to claim 15, wherein the information template recorded on the marking plate is painted onto the surface of the marking plate.

17) The information marking plate according to claim 15, wherein the information template recorded on the marking plate is engraved onto the surface of the marking plate.

18) The information marking plate according to claim 15, wherein the information template recorded on the marking plate is laser etched onto the surface of the marking plate.

19) The information marking plate according to claim 15, wherein the information template recorded on the marking plate is acid etched onto the surface of the marking plate.

20) The information marking plate according to claim 15, wherein the information template recorded on the marking plate is printed onto the surface of the marking plate.

21) The information marking plate according to any of claims 13 through 20, wherein the securing means is comprised of a ring clasp passing through a hole in the marking plate and wherein said ring clasp is to further pass through a hole in the corresponding electric fixture, thereby securing the information marking plate to the electric fixture.

22) The information marking plate according to any of claims 13 through 20, wherein the securing means is comprised of at least one (1) pop rivet passing through a hole of sufficient size in the marking plate and into the electric fixture, thereby securing the information marking plate to the electric fixture.

23) The information marking plate according to any of claims 13 through 20, wherein the securing means is comprised of at least one (1) screw passing through a hole of sufficient size in the marking plate and into the electric fixture, thereby securing the information marking plate to the electric fixture.

24) The information marking plate according to any of claims 13 through 20, wherein the securing means is comprised of an adhesive material applied to the side of the marking plate opposite to the side of the information marking plate on which the information template is recorded, with said adhesive side of the marking plate to be affixed to the electric fixture, thereby securing the information marking plate to the electric fixture.

25) The information marking plate according to claim 13, wherein the table or organized array of corresponding standardized electrical and circuitry data comprising the information template relates to low voltage electric landscape lighting.

26) The information marking plate according to claim 25, wherein the organized array of corresponding standardized electrical and circuitry data comprising the information template contains, in whole, in part, or in combination, fields as to the identification of the wire run, transformer, lamp type, wattage, and hours, fixture type and number of fixtures on the wire run.

27) A method of archiving electrical data or information concerning an electric device or fixture, comprising the steps of:
(a) recording an information template onto at least one side of a marking plate, said information template comprised of at least one table or organized array of corresponding standardized electrical and circuitry data relevant to an electric device or fixture and of which said data is used by and commonly known to electricians and those skilled in the art, from which specific relevant electrical information concerning the device or fixture and its circuitry may be selected for marking;
(b) collecting electrical and circuitry information with respect to the particular electric device or fixture;
(c) recording said device or fixture specific electric and circuitry information within the corresponding data areas of the information template; and
(d) affixing the information marking plate to the electric device or fixture.
